(19) United States
(12) Patent Application Publication
(10) Pub. No.: US 2013/0332110 A1
(43) Pub. Date: Dec. 12, 2013

(54) NON-ITERATIVE MAPPING OF CAPPED CYLINDRICAL ENVIRONMENTS

(71) Applicants: Cynthia Dawn Walker Panas, Cambridge, MA (US); Robert Matthew Panas, Cambridge, MA (US); Kamal Youcef-Toumi, Cambridge, MA (US)

(72) Inventors: Cynthia Dawn Walker Panas, Cambridge, MA (US); Robert Matthew Panas, Cambridge, MA (US); Kamal Youcef-Toumi, Cambridge, MA (US)

(73) Assignee: Massachusetts Institute of Technology, Cambridge, MA (US)

(21) Appl. No.: 13/491,672

(22) Filed: Jun. 8, 2012

(51) Int. Cl. G06F 17/18

(52) U.S. Cl. 702/179

(57) ABSTRACT

Method for mapping capped cylindrical environments. The method uses an algorithm for creating an environment map through 3D data segmentation and fitting of right planar capped cylinders. The algorithm implementing the method of the invention offers improved robustness, accuracy and speed over existing segmentation and fitting methods. The improved properties of the invention are achieved through the use of a Gauss map, 3D histogram and shape knowledge driven segmentation. Performance was demonstrated on a variety of cylinders using simulated data.

### BACKGROUND OF THE INVENTION

This invention relates to a method for fitting three-dimensional data to a capped cylinder for use, for example, with a robotic tank inspection system, and more particularly to such a method that does not require iteration to find the best fit.

Liquefied petroleum gas (LPG) tanks are hazardous environments for inspection. LPG is cryogenically cooled into a liquid and stored in large (approximately 98 m diameter) tanks. These tanks must be periodically inspected, but pose significant hazards to the inspector. The temperatures are around −160 C and the fumes are explosive. The tank sits on a concrete slab so the floor is not accessible from the outside. Inspection must be done from inside.

Current methods to inspect the floor of LPG tanks are expensive and energy intensive [1]. The first step is to remove the LPG. The tank is then gradually warmed and a human inspector is 15 s sent in. The process of warming the tank to temperatures safe to send in an inspector can take up to two weeks due to the need to gradually warm the tank to avoid explosions. The inspection and cooling of the tank adds further time requirements. This leaves the tank out of commission for several weeks resulting in lost revenue. The heating and cooling is also expensive and uses significant energy.

A robotic inspection system will make the inspection system much more efficient. The tank will not need to be warmed as much as is necessary for a human inspector. This will shorten the down time, thus less revenue will be lost. This also means that there will be less energy necessary to cool the tank back down to operating temperatures. The inspection process itself can be done more quickly and thoroughly because the robots will move along prescribed paths more accurately than human inspectors. The risk is also diminished because robots are not sensitive to the same hazards as human inspectors.

Mobile robots often use range measuring sensors to determine the extents of their environment [2]. Advances in laser range finders have made them commonplace in mobile robot navigation systems. The data collected by these sensors need to be processed in order to create 3D maps of the environment.

Processing the data most often involves segmentation and then fitting each section to mathematical descriptions, mainly geometric primitives [3][6]. The mathematical descriptions of each geometric primitive make up the map of the surrounding environment which can then be used in movement or other interaction algorithms. The basic segmentation methods used by most current methods of segmentation can be broadly sorted into three categories: Clustering, Seed and Grow, and Hough Transform.

In clustering, properties of each data point are compared. Points with similar properties are grouped together through iteration. Usually these properties are similarity in position and orientation of the surface normal at that point [7]. Clusters are considered to be parts of separate surfaces when the properties in that cluster lie outside the user defined threshold for similarity.

Seed and Grow is similar to clustering in that it groups together points with similar properties, however to find these features, random “seeds” are selected and neighboring points are compared and collected until there is a large discrepancy. Once the neighboring points of the growth section fall outside of a threshold for similarity, another seed is chosen and the process repeats until all points are used. A final sweep combines homogeneous regions [6][7].

The Hough Transform relies on a voting procedure to find the most common geometric parameters for a given area. The true parameters of the geometric primitive composing the surface of interest should show up as the most common measurements, but may be distributed by noise. A histogram-based analysis of the parameters will show the dominant value, corresponding to the actual parameters of the geometric primitive. [8][9].

These methods are very flexible, but there is room for improvement when segmenting inspection environment data. Processing the data from range sensors into a map is often computationally expensive and time consuming. The resource demands are particularly large when the environment is completely unknown. Most methods using the above processes of segmentation assume nothing about the environment from which the data they are segmenting comes. This makes the algorithms very flexible because no external information is needed and they are not limiting what the fit outcome should be. The downside is that they all rely on iteration to find the best fit. Fortunately, the general structure of the inspection environment is known in the case of inspection robots. This information may be used to provide basic estimates of shape that reduce the need for computationally expensive iteration. This shape knowledge offers the potential to make the new algorithm significantly faster than the existing segmentation methods.

### SUMMARY OF THE INVENTION

The method for mapping capped cylindrical environments according to an aspect of the invention includes collecting data from a distance range sensor within a capped cylinder. A group of N neighbors surrounding a point of interest at a radius R is collected and the normal at each sample data point is found from the N neighbors. The data is then segmented into groups and planes are fitted to the roof and floor and a circle is fitted to wall data. In a preferred embodiment, the sensor is a laser range sensor. A suitable method for finding the normal uses least squares plane filling. In this embodiment, the segmenting step including aligning coordinate frames at the cylinder and sensor locations. It is preferred that the fitting step uses a Gauss image.

In another preferred embodiment, the number of neighbors is at least three. It is also preferred that the method include the step of inputting constants based on fit requirements. Suitable constants are accuracy of desired fit; sensor resolution; encoder step resolution, estimate of cylinder height; and estimation of cylinder radius.

The algorithm implementing the method of the invention offers improved robustness, accuracy and speed over existing segmentation and fitting methods. These improved properties are achieved through the use of a Gauss map, three dimensional histogram and shape knowledge driven segmentation.

### BRIEF DESCRIPTION OF THE DRAWING

FIG. 1 is a schematic representation of a cylindrical tank having a sensor mounted in a wall of the tank according to an embodiment of the invention.

FIGS. 2a and 2b are schematic illustrations of the mapping of an uncapped cylinder and a plane onto a Gaussian sphere.

FIGS. 3a and 3b are simulated raw data and a histogram of Gaussian sphere normals.

FIG. 4 is an illustration of the isolation of floor data.

FIG. 5 illustrates cylinder fitting steps and final completed fitting.

FIG. 6 is a graph of percent error in fits versus neighborhood radius as a fraction of either cylinder diameter or height, whichever is smaller according to an embodiment of the invention.

FIG. 7 are graphical illustrations showing raw data, fits and fit accuracies of varying simulated tests of the method according to an embodiment of the invention disclosed herein.

### DESCRIPTION OF THE PREFERRED EMBODIMENT

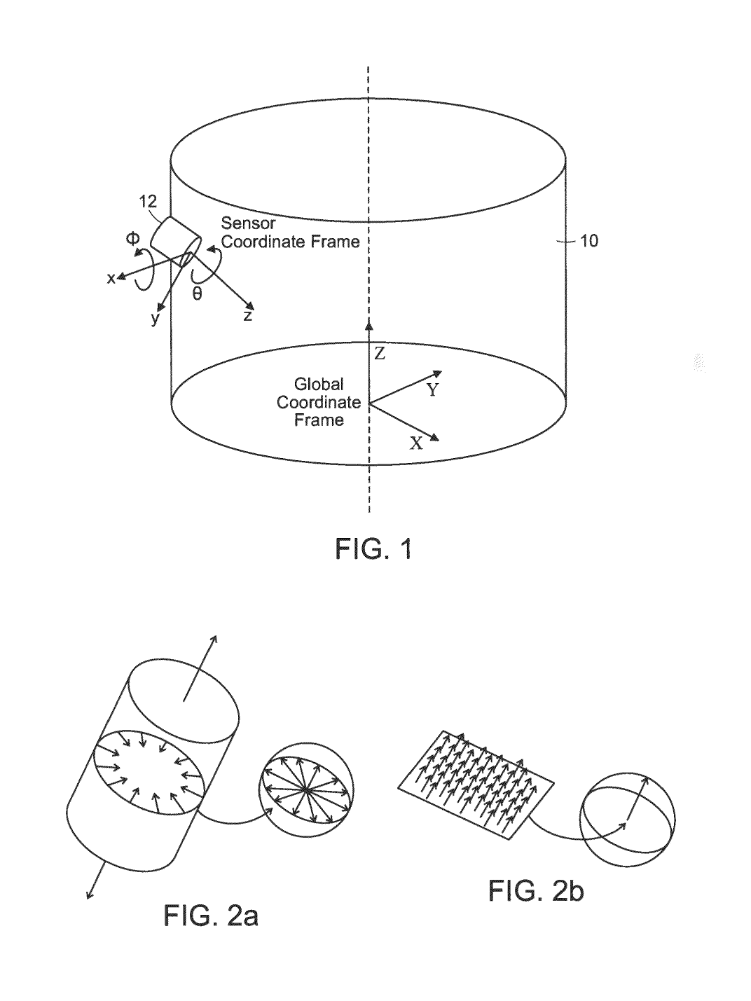

Here we describe the algorithm designed to fit planar capped cylinders to data collected from a laser range finder. Consider a cylindrical tank 10 and laser range sensor 12 located on its wall as depicted in FIG. 1. The cylinder 10 has a right handed coordinate frame designated by X, Y and Z. The Z axis is aligned with the center axis of the cylinder. The sensor 12 has its own coordinate frame designated by θ, φ and z where the z axis is aligned with lens of the sensor at 105 the time of startup. The θφz coordinate frame is the frame of reference the algorithm uses. It does not initially know the orientation of XYZ in relation to θφz.

The orientation of the sensor as it moves during data collection is measured by the amount of rotation in φ and θ. The distance from the sensor to the surface it is measuring, along the z axis, will be referred to as d. Some aspects of calculation are easier to accomplish in a 110 rectangular coordinate frame. In these instances the sensor rectangular coordinate frame designated by x,y,z can be derived from θ, φ and z. xyz and θφz are related by:

x=d sin φ cos θ

y=d sin φ sin θ

z=−d cos φ (1)

The best data collection process for this algorithm involves a nearest-neighbors method [10]. Sampled points are evenly distributed about a unit cube in the xyz coordinate frame. After the location of the sensor, θ and φ, and the distance to the surface, d, for each sample is collected, a group of N neighbors surrounding the point of interest at a radius R are also collected. This neighborhood is used to find the normal at each sampled data point using least squares plane fitting. Previous implementations of this method have determined N and R through trial and error [10]. A noise analysis was carried out to determine the best values and is discussed below.

There are three steps of segmentation which follow data collection. The first step of segmentation is locating the orientation of the Z axis in terms of θφz. Next the Z axis is aligned with the z axis through coordinate transforms. Once the two frames are aligned the data is segmented into groups corresponding to the floor, roof and walls. The fitting process consists of fitting planes to the roof and floor and a circle to the wall data. These three fits in addition to the rotation of the sensor origin through the transformation matrix defines the extents of the tank.

The process of aligning the coordinate frames then breaking the data into geometric primitives was chosen over fitting an arbitrarily rotated cylinder for several reasons. The first is to simplify the segmentation process. Traditional least squares fitting of a 3D rotated cylinder in space cannot handle the data corresponding to the capped ends. The excess data biases the result, ruining the cylinder fit. This suggests that the roof and floor data should be separated from the wall data. The segmentation methods listed above can accomplish this, but they are computationally expensive due to their iteration steps. Aligning the two coordinate frames places the cylinder (the XYZ frame) into a known arrangement. This allows us to remove the need for iteration, greatly reducing the computational load and speeding up the process. Another advantage of the rotation method is that non-uniformly distributed data does not cause a bias fit. The lack of bias is due to the location based method of segmenting the data points instead of the common property methods of segmentation. In addition, the walls are known to be vertical, thus we can constrain results to that orientation, reducing the degrees of freedom of the fitting algorithm and thus improving the accuracy of the fit.

While fitting data to cylinders has been done using multiple methods, all these processes have looked at data where the cylinder is modeled as infinite. The ends, or caps, either do not exist, as in the case of fitting to pipes in a building [5], or they have been processed separately [6]. One aspect that is unique to the method discussed herein is the integration of the caps in the cylinder fitting. This is achieved through the use of the Gauss image.

The Gauss image is formed through the placement of the ends of normals, collected from a surface, onto the origin. These normals then intersect a unit sphere, referred to as the Gaussian sphere, forming a Gauss map [4]. The resulting image when the entire surface is mapped is the Gaussian image. The Gaussian image of an uncapped cylinder is a circle on the Gaussian sphere as shown in FIG. 2a. The mapping of a plane onto the Gaussian sphere is a single point, repeated as shown in FIG. 2b.

This algorithm is intended to work with cylinders composed of planar caps. The cylinder is then a combination of two planes and a cylinder. This means one can expect the Gaussian image to be a combination of the two images shown in FIG. 2; the cylindrical walls will have a wide spread of points while the floor and roof planes will result in many repeated points on the Gaussian sphere. It is easy to identify the normal to the floor plane because it is the normal corresponding to the most common repeated point on the Gaussian sphere. Depending on the orientation of the cylinder, the roof may instead be the most common repeated point, but since the roof and floor normals will be mirror images, once one is identified the other is known and can be used to correctly orient the tank. This is done if the first fit resulted in a tank with illogical locations of the planes, such as the top of the cylinder being at 0 m and the floor being −75 m.

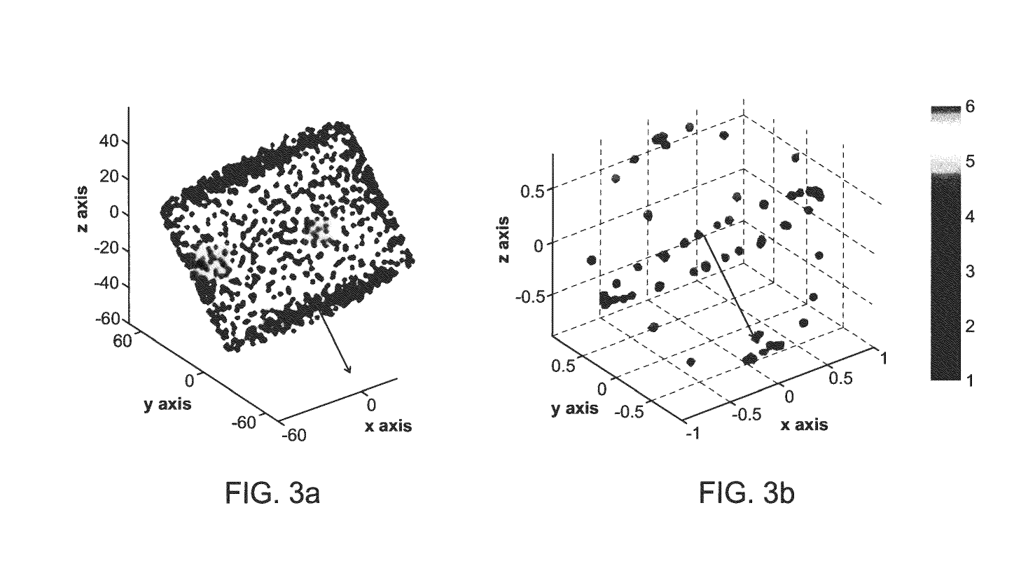

The coordinates of the points on the Gaussian sphere are collected and sorted into a 3D histogram in order to identify the Z axis. The histogram is composed of bins corresponding to the coordinates of the points on the Gaussian sphere. The histogram bin containing the most “votes” will correspond to the normal of the cap. FIG. 3a shows simulated raw data of a tank. FIG. 3b shows a histogram of the normals on the Gaussian sphere. The bright point indicates multiple normals pointing in that direction, which corresponds to the normal to the tank floor as expected. The ring corresponds to the normals drawn on the circular walls of the tank. Finally, the noise-like points distributed over the unit sphere are drawn from plane fits in the corners of the tank. The most common point corresponds to the normal of the tank cap. This normal, hereafter referred to as N̅_{cap}, lies along the Z axis of the global coordinate frame.

The cylinder is oriented in a known arrangement through the alignment of the sensor and global coordinate frames. The sensor z axis is aligned with N̅_{cap}, which corresponds to the cylinder Z axis, through the use of a rotation matrix. The axis of rotation is found from:

rotaxis= N̅_{cap}×(0,0,1) (2)

and the angle about which to rotate is found from:

θᵣₒₜ=cos⁻¹( N̅_{cap}·(0,0,1)) (3)

A rotation matrix using the rotaxis and θᵣₒₜ orients the cylinder along the z axis which is what allows for the non-iterative segmentation.

In order to easily fit the floor and roof planes and the cylinder to the walls, the data needs to be sectioned into the corresponding regions. Once the data has been rotated, the floor data can be identified as the data with z values below the clean floor height and with x and y values that are within the clean floor radius. The clean floor height and radius are calculated by modifying the 5^{th} and 95^{th} percentile values of the data according to the acceptable estimate error.

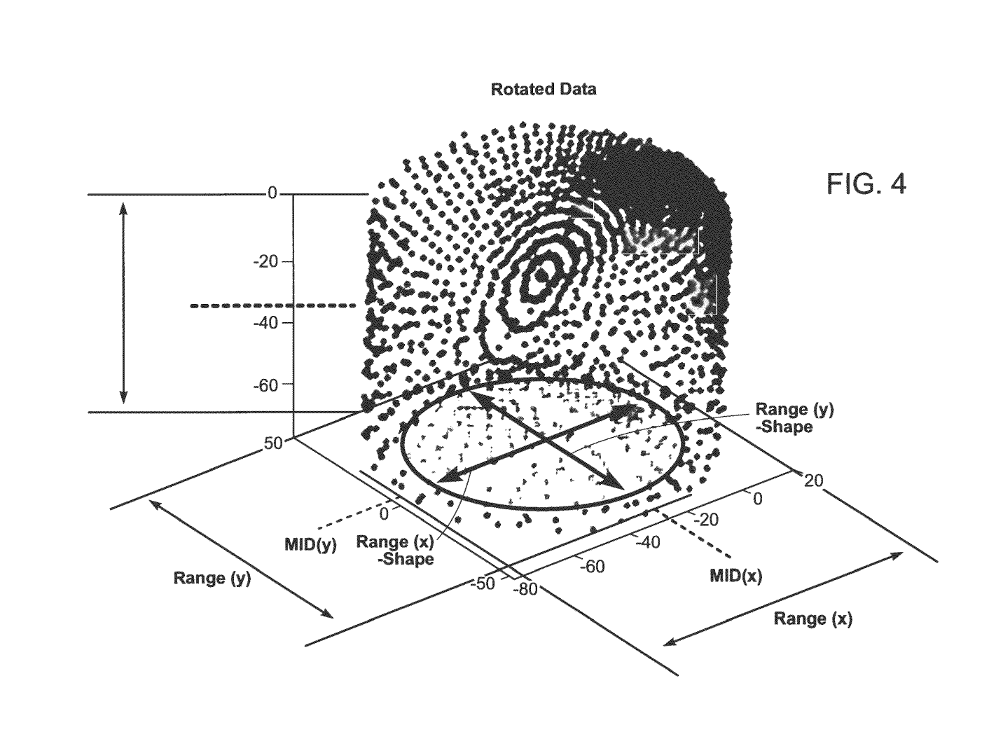

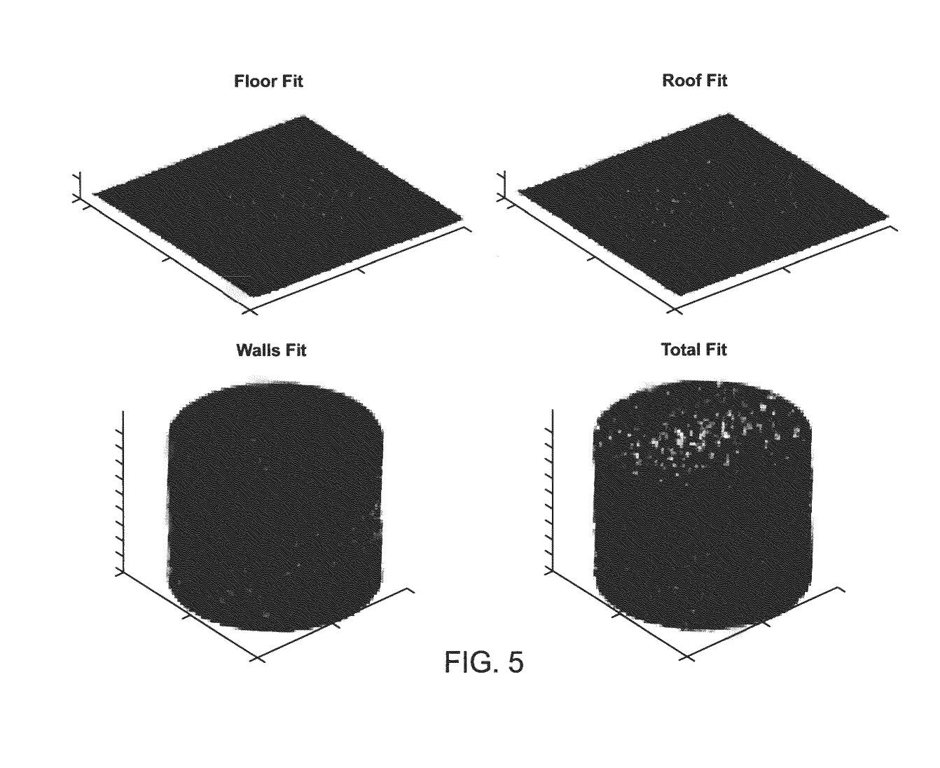

The isolation of the floor data is shown in FIG. 4.

The same isolation process is completed for the roof, except the only values collected are those above a calculated clean roof height and within the clean radius. The wall data is collected by finding points that are less than the clean roof height, but above the clean floor height and are outside the clean radius.

Simple least squares fitting of each set of data results in the tank map. The floor and roof sets are fit to planes as shown in the top row of FIG. 5. The distance between the minimum (floor) and maximum (roof) planes defines the height of cylinder. The radius of the tank is identified by neglecting the height data in the wall set and completing a least squares fit of the rest of the wall data to a circle. The height of the wall is assumed to be the height of the cylinder. This wall fit is shown in the bottom left of FIG. 5. The new origin is defined in relation to the 3D cylinder from the rotation of the sensor origin through the same rotation matrix as used above. With these three sets of information, the origin, the radius and the height, the cylinder is mathematically defined. Mathematically defining the extents of the cylinder creates a map of the environment which is shown in the bottom right of FIG. 5.

The algorithm described above requires the designer to input five constants based on the fit requirements. These are 1) the accuracy of the desired fit, Acc, 2) the resolution of the distance sensor, σₛ, 3) the resolution of the encoder, σₑ, 4) a rough estimate of the height of the tank, H_{rough}, and 5) a rough estimate of the radius of the tank, R_{rough}. These inputs are used to calculate three variables: the neighborhood radius R, the number of neighbors N, and the total number of normals, Nₜₒₜ which are used in the identification of N̅_{cap}.

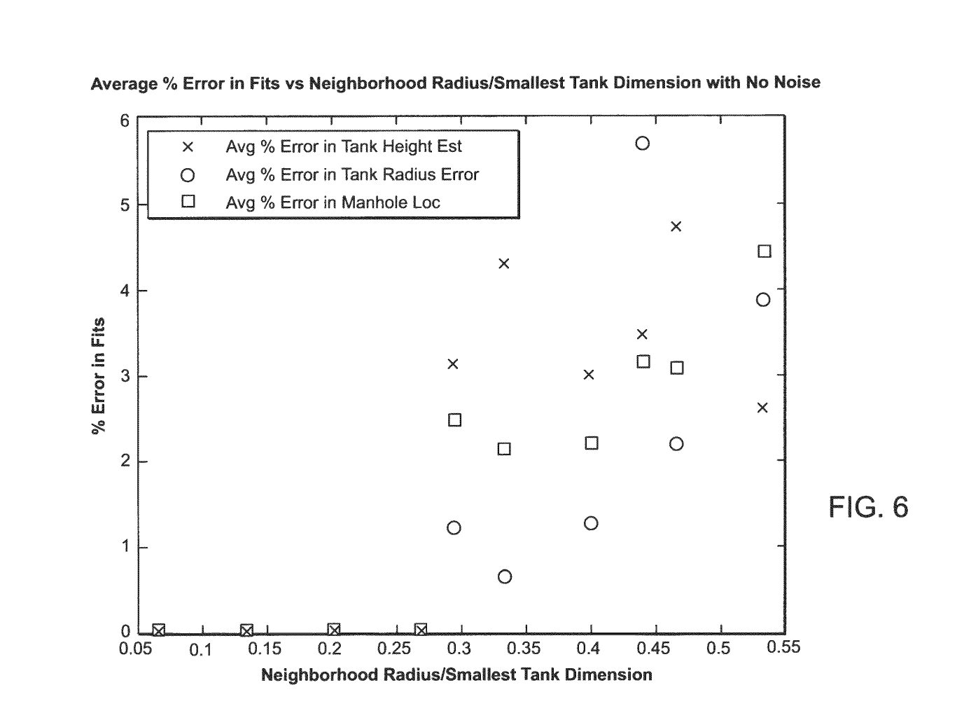

R is determined by the size of the tank and noise in the sensor. The neighborhood plane fit error will become relatively large if the R is too small and the normal fit will suffer. There will be a smoothing effect where the walls and corners will generate spurious normals if R is too large. The designer should use the largest R that will not result in excessive smoothing. FIG. 6 shows the resulting percentage error of the fit when different values of R are used. In these tests there was no noise added to the simulation in order to easily identify only the result from having a neighborhood that is too large. The figure indicates that a safe upper size for the normal neighborhood is about 20% of the tank height or diameter, whichever is smaller. The algorithm uses 20% of the smaller of H_{rough} and R_{rough}.

The number of neighbors, N, used in the normal calculation also affects the accuracy of the fit and the time to run. The absolute minimum number of neighbors is three in order to guarantee enough information for a plane fit.

More than three neighbors increases the accuracy as the noise is averaged out, but it takes more time to run. The optimal N is the minimum number of neighbors for which the algorithm will achieve the desired accuracy or three, whichever is larger. The desired accuracy, Acc, must be converted to the allowable angular error of the estimated tank floor normal and the actual tank floor normal, Err, to determine the N needed to achieve the desired accuracy as shown in equation 4,

$$Err = {cos}^{- 1} ( 1 - \frac{Acc}{2} ) \qquad ( 4 )$$

An equation for N can be calculated from the sensor and encoder errors, σₛand σₑ, the neighborhood radius, R, the estimated height and radius, H_{rough} and R_{rough}, the distance of the sensor from the wall as determined by the geometry of the sensor platform, s, and the acceptable angular error Err using equation 5.

$$N = {( 2 * \frac{2.26 \sqrt{2 {( \frac{{max ( {H}_{rough} , {R}_{rough} )}^{2} R}{3 s} )}^{2} + {σ}_{s}}}{R * Err} )}^{1.79} \qquad ( 5 )$$

R and N can be derived from the user inputs as described above, or the user can modify them directly. These values are derived using equations that optimize the fit at the expense of time. If time is more critical to the application, the designer can tweak the values of R and N down to decrease the time. If the sensor is ideally located, these numbers could be very small. If the sensor is located in a difficult position, such as near a corner, there may not be much the designer can do without losing accuracy.

Although not an input, the number of normals to find before moving on to the segmentation step, Nₜₒₜ, is important to the accuracy of the fit. This forms another tradeoff between time and accuracy. Measurements of about 50 normals have been found to work in most cases, but significantly higher values (upwards of 200) are needed when the sensor is placed in the extreme corners of the tank. As a default, 218 normals are used in order to guarantee a good fit. The designer can lower this value to achieve better processing time if the sensor is not badly located.

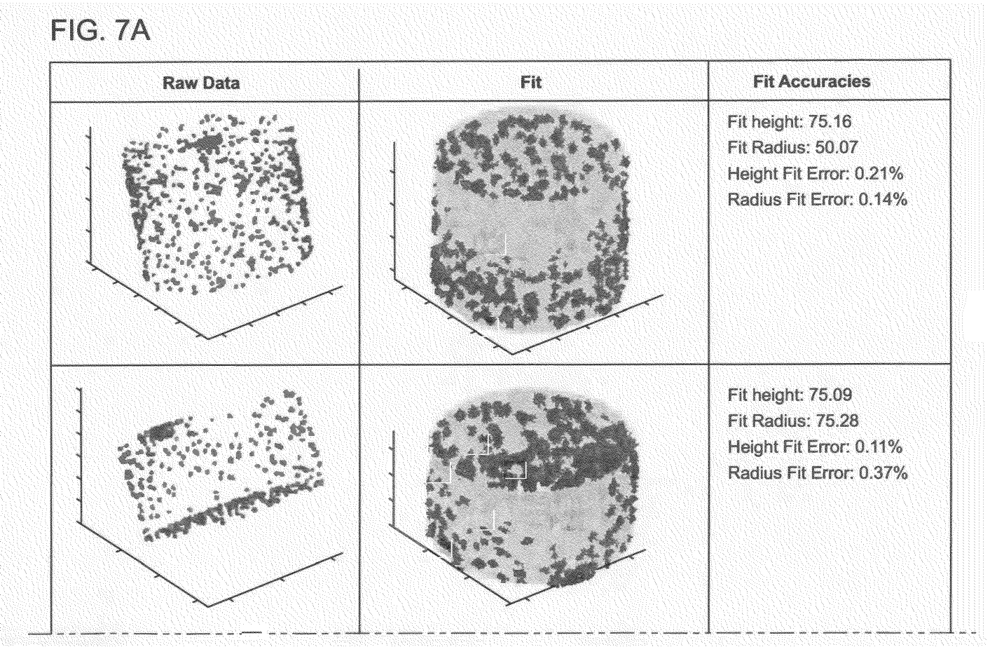

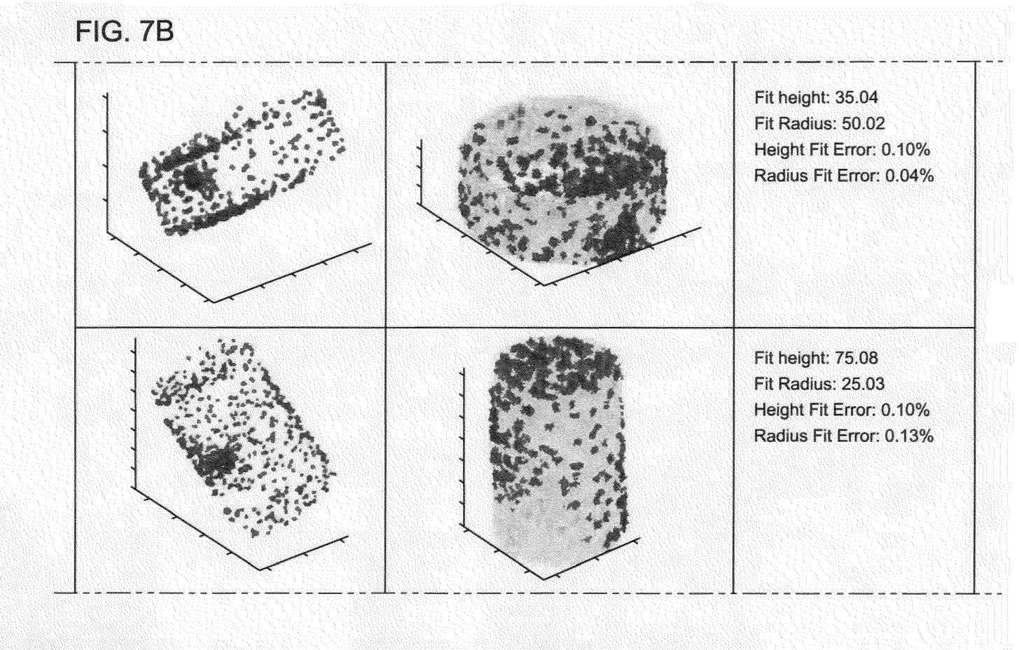

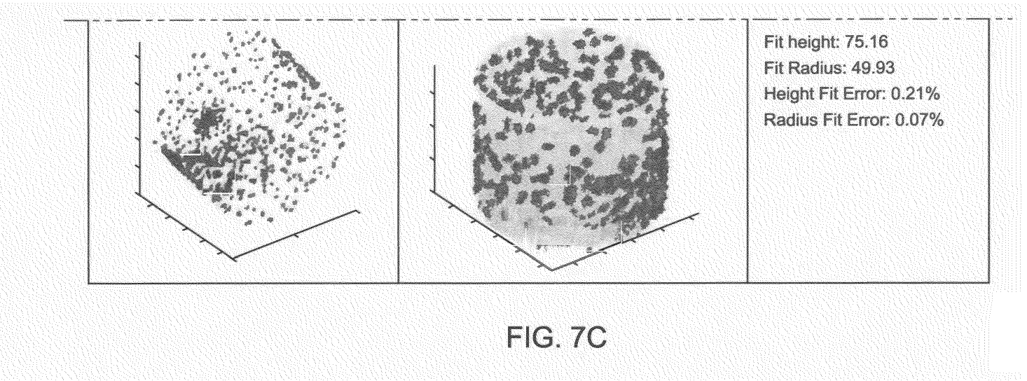

The algorithm disclosed herein was developed and tested using simulated data. The simulation was able to produce data with varying origin locations, tank heights and radiuses, cylindrical rotation and noise values. The input characteristics gave a ground plane against which the fit may be tested. The algorithm is able to fit a mathematical model within the specified accuracy given variation in all parameters. FIG. 7 shows 5 sample test runs using the simulation. The simulated sensor was rotated by 15, 30, 45, 60 and 75 degrees with the tank height varying tank height to radius ratios and manhole locations. All fits were done using a desired accuracy of 1% of the tank's smaller dimension and a sensor noise of 0.02 m as this is the accuracy of the sensor we are planning to implement with. As indicated in column 3, the desired accuracy was always achieved.

The contents of all of the references cited herein are incorporated into this application by reference.

### REFERENCES

[1] H. Schempf, “Neptune: above-ground storage tank inspection robot system,” IEEE International Conference on Robotics and Automation, vol 2, pp. 1403-1408, 1994
[2] J. Pascoal, L. Marques and A. T. de Almeida, “Assessment of Laser Range Finders in risky environments,” IEEE International Conference on Intelligent Robots and Systems, vol September 265 2008, pp. 3533-3538, 2008
[3] P. F. U. Gotardo, O. R. P. Bellon and S. Luciano, “Range Image Segmentation by Surface Extraction Using an Improved Robust Estimator,” IEEE Computer Society Conference on Computer Vision and Pattern Recognition (CVPR '03), vol 2, pp. 22, 2003
[4] A. Gray, Modern Differential Geometry of Curves and Surfaces. Boca Raton, Fla.: CRC 270 Press, Inc, pp. 193, 1993.
[5] T. Chaperon and F. Goulette, “Extracting cylinders in full 3D data using a random sampling method and the Gaussian image”, in Proc VMV 2001, Stuttgart Germany, pp. 35-42, 2001
[6] G. Lukacs, R. Martin and D. Marshall, “Faithful Least-Squares Fitting of Spheres, Cylinders, Cones and Tori for Reliable Segmentation,” presented at the European Conference on Computer Vision (ECCV'98), Freiburg, Germany, 1998.
[7] A. Hoover, G. Jean-Baptiste, X. Jiang, P. J. Flynn, H. Bunke, D. B. Goldof, K. Bowyer, D. W. Eggert, A. Fitzgibbon and R. B. Fisher, “An experimental comparison of range image segmentation algorithms,” IEEE Trans. Pattern Analysis and Machine Intelligence, vol. 18, no. 7 pp. 673-689, July 1996.
[8] U. Larsson, J. Forsberg and A. Wernersson, “On robot navigation using identical landmarks: integrating measurements from a time-of-flight laser,” IEEE International Conference on Multisensor Fusion and Integration for Intelligent Systems, vol October 1994, pp. 17-26, 1994
[9] J. Forsberg, U. Larsson, A. Wernersson, “Mobile robot navigation using the range-weighted Hough transform,” IEEE Robotics & Automation Magazine, vol. 2, no. 1, pp. 18-26. March 1995
[10] H. Hoppe, T. DeRose, T. Duchame, J. McDonald and W. Stuetzle, “Surface Reconstruction from Unorganized Points,” Computer Graphics, vol. 26(2), pp. 71-78, 1992.

What is claimed is:

1. Method for mapping capped cylindrical environments combining:
collecting data from a distance range sensor within a capped cylinder;
collecting a group of N neighbors surrounding a point of interest at a radius R;
finding from the N neighbors the normal at each sampled data point;
segmenting the data into groups corresponding to floor, roof and walls of the cylinder; and
fitting planes to the roof and floor, and a circle to wall data.

2. The method of claim 1 wherein the sensor is a laser range sensor.

3. The method of claim 1 wherein the finding of the normal uses least squares plane fitting.

4. The method of claim 1 wherein the segmenting step includes aligning coordinate frames at the cylinder and sensor locations.

5. The method of claim 1 wherein the fitting step uses a Gauss image.

6. The method of claim 1 wherein N is at least three.

7. The method of claim 1 further including the step of inputting constants based on fit requirements.

8. The method of claim 7 wherein the constants are accuracy of desired fit as a function of actual size; standard deviation of range sensor noise; estimate of cylinder height; and estimate of cylinder radius.
